(19) United States
(12) Patent Application Publication
(10) Pub. No.: US 2013/0017876 A1
(43) Pub. Date: Jan. 17, 2013

(54) VIDEO GAME WITH BEHAVIOR INDICATORS AND CONTROLLER THEREFOR WITH INTEGRATED DISPLAY SCREEN

(71) Applicant: John Koumbourlis, Kirkland (CA)

(72) Inventor: John Koumbourlis, Kirkland (CA)

(21) Appl. No.: 13/576,033

(22) PCT Filed: Feb. 11, 2010
(86) PCT No.: PCT/CA2010/000200

§ 371 Date: Jul. 30, 2012

Related U.S. Application Data
(60) Provisional application No. 61/202,254, filed on Feb. 11, 2009.

(51) Int. Cl. A63F 13/12

(52) U.S. Cl. 463/11

(57) ABSTRACT

A video card game for a plurality of players comprises a common interface and a plurality of private interfaces. The common interface is viewable by all the players and displays a plurality of computer avatars, each corresponding to a given payer and holding a respective hand of cards corresponding to a hand ranking. Each private interface displays one given hand of cards of one given avatar. The players selectively replace one card or more of their respective hand to modify their ranking. A given player's hand is selectively displayed on the common interface to allow all the players to assess the ranking of this player. A video card game also comprises a controller for each player for selectively controlling their respective avatar and a social meter for modulating the behavior indicators of their avatar which are displayed by the common interface so as to be viewable by all the players.

### FIELD OF THE INVENTION

The present invention relates to a video game and a controller. More specifically, but not exclusively, the present invention relates to a video game with behavior indicators and a controller therefor with an integrated display screen. More particularly, but still not exclusively, the present invention relates to a video card game.

### BACKGROUND OF THE INVENTION

Computer video card games and internet card games such as Video Poker are well known. On-line card games have become popular since traditional venues such as casinos and poker rooms may be intimidating for novice players. On-line card games also allow players from remote areas to compete against each other. Off-line video card games are also widely used but remain less popular than on-line games.

Even though on-line card games present a variety of advantages with respect to traditional table games, such as the ability to compete with players from around the world, or to play simultaneously on multiple tables or even the use of a computerized dealer who can collect, shuffle and deal faster than a human dealer, there is a substantial disadvantage which takes away from the excitement and intrigue of a face to face game. This obvious difference is that players do not sit right across from each other, removing any ability to observe others' reactions and body language. Instead, online card players learn to focus more keenly on betting patterns, reaction time, speed of play, use of check boxes/auto plays, opponents' fold/flop percentages, and the like. There is no way to sense the stress of one's opponents or try to perceive if your opponent is bluffing. This obvious difference greatly diminishes the card game experience.

Off-line card games between people in the same room using a common interface (e.g. computer display screen) are inconvenient since players cannot hold their private Hole Card hand from their opponent's view. As such, these card games are usually played on an individual basis.

There exists a variety of handheld control units with integrated screens that do not provide sufficient privacy to each player similar to that of a physical Hole Card hand.

### OBJECTS OF THE INVENTION

An object of the present invention is to provide a video game with behavior indicators.

An object of the present invention is to provide a video game controller with an integrated display screen for allowing multiple players to compete wherein the scene displayed on the handheld unit differs from the scene displayed on the handheld unit of another player and from the common interface, common to all players.

An object of the present invention is to provide a video card game.

### SUMMARY OF ILLUSTRATIVE EMBODIMENTS

A video card game for a plurality of players comprising:

a common interface viewable by all the players and displaying a plurality of computer avatars, each avatar corresponding to one given player and holding a respective hand of cards corresponding to a hand ranking that is selectively not displayed by the common interface; and

a plurality of private interfaces, each private interface displaying one given hand of cards of one given avatar, the one given hand of cards being selectively viewable only by the player that this one given avatar corresponds to,

wherein the players selectively replace one card or more of their respective hand of cards for modifying their respective hand ranking, wherein a given hand of cards is selectively displayed on the common interface thereby allowing all the players to assess the hand ranking thereof.

A video card game for a plurality of players comprising:

a common interface viewable by all the players and displaying a plurality of computer avatars, each avatar corresponding to one given player and holding a respective hand of cards corresponding to a hand ranking;

a controller for each player for selectively controlling their respective avatar for replacing one card or more of their respective hand of cards thereby modifying their respective hand ranking; and

a social meter for modulating a behavior indicator selected from a group of predetermined behaviors for each avatar based on the hand ranking,

wherein the behavior indicator for each avatar is displayed by the common interface so as to be viewable by all the players.

A method of playing a video card game for a plurality of players comprising:

providing a common interface viewable by all the players and displaying a plurality of computer avatars;

assigning each avatar to one given player;

providing for each player to control their corresponding avatar;

dealing a virtual hand of cards to each avatar, the hand of cards being selectively not viewable by the common interface;

providing a private interface to each player so as to view their virtual hand of cards corresponding to a hand ranking;

each player selectively replacing one card or more card from of their respective virtual hand of cards for modifying their respective hand ranking; and

each player selectively displaying their virtual hand of cards on the common interface thereby allowing all the players to assess their hand ranking.

A method of playing a video card game for a plurality of players comprising:

providing a common interface viewable by all the players and displaying a plurality of computer avatars;

assigning each avatar to one given player;

providing for each player to control their corresponding avatar;

dealing a virtual hand of cards to each avatar corresponding to a hand ranking;

each player selectively replacing one card or more card from of their respective virtual hand of cards for modifying their respective hand ranking; and

causing each avatar to indicate a behavior selected from a group of predetermined behaviors so as to be viewable by the players via the common interface.

An apparatus for a video card game for a plurality of players comprising:

a common interface viewable by all the players and displaying a plurality of computer avatars corresponding to each player with each avatar holding a hand of cards;

a controller for each avatar, the controller comprising a private interface for displaying a given said hand of cards of a given said avatar.

In accordance with a non-restrictive illustrative embodiment, there is provided a video game including a generally common scene displayed to all players as well as different scenes displayed individually to each player.

In accordance with a non-restrictive illustrative embodiment, there is provided a system for a video game comprising at least one handheld unit with an integrated screen and at least one common display for allowing multiple players to compete in the same or different locations, and for enabling a scene displayed on a given integrated video display of one player to be different than a scene displayed on another integrated video display of another player.

In an embodiment, there is provided an apparatus comprising the foregoing system.

In accordance with a non-restrictive illustrative embodiment, there is provided a handheld unit having a screen for a video display and a protective shield about the screen.

In accordance with a non-restrictive illustrative embodiment, there is provided a video card game comprising a common playing scene with avatars displayed on a common image, each avatar being controlled by a given player, each avatar holding a respective card hand, each respective card hand viewable only to the player associated with that avatar via an auxiliary image; each avatar subject to behavior indicators determined by a current card score and/or by the game longevity and and/or by stress-relieving habits selectively prompted by the player.

Other objects, advantages and features of the present invention will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is a block diagram of a gaming network or environment showing a server linked via the internet to five different gaming environments or locations in accordance with a non-restrictive illustrative embodiment of the present invention;

FIG. 2 is an enlarged block diagram of one of the gaming environments of FIG. 1, showing a terminal with a common image and three handheld controllers with respective images;

FIG. 3A is a rear perspective view of the handheld controller in accordance with a non-restrictive illustrative embodiment of the present invention;

FIG. 3B is a top plan view of the handheld controller of FIG. 3A;

FIG. 4 is an enlarged block diagram view of another gaming environment of FIG. 1 showing a terminal with a common image and a sub-image;

FIG. 5 is a block diagram of an off-line gaming environment having a terminal to display a common image and a plurality of handheld units for each player to view a respective private image;

FIG. 6 shows block diagram representation of a gaming environment showing a common image and a plurality of handheld units for each player to view a respective private image, the common image includes avatars for each player as well as an icon for displaying a behavior indicator;

FIG. 7 is a block diagram representing the social meter and the behavior indicator of the video card game of the present invention in accordance with a non-restrictive illustrative embodiment thereof;

FIG. 8 is an enlarged view of the Confidence Meter block of FIG. 7;

FIG. 9 is an enlarged view of the Stress Meter block of FIG. 7;

FIG. 10 is an enlarged view of the Score Meter block of FIG. 7;

FIG. 11 is an enlarged view of the Composure Meter block of FIG. 7; and

FIG. 12 is an enlarged view of the Habit Controller block of FIG. 7.

### DETAILED DESCRIPTION OF ILLUSTRATIVE EMBODIMENTS

Generally stated and in accordance with non-restrictive illustrative embodiments thereof, the invention concerns an on-line and/or off-line computerized video card game, such as a Poker game. The card game provides computer generated character avatars to be displayed in a common interface including image or scene viewable by each player. Each player is assigned and controls a respective avatar. Each player has a hand of cards viewable only to them; this is accomplished by way of a private interface or auxiliary image in the form of a portion of the common screen such as sub-image box appearing on a screen or via a handheld console or unit having an integrated screen. The hand of cards corresponds to a hand ranking. In essence, the avatars are each dealt a respective virtual hand of cards. Various card games, such as poker have various scoring systems, these various scoring systems provide a hand ranking to each player relative to the other player. During the game, each player controls their avatar via a controller and selectively replaces one card or more so as to modify their hand ranking. Each player is provided with a turn to play for executing a play activity. Play activities can include replacing a card, making a bet, passing their turn, folding their hand, revealing their hand or any combination thereof and the like.

A social meter dependent on several factors produces behavior indicators which result in body language or actions in the avatars, in order to emulate a face to face card game. The social meter modulates a behavior indicator. The behavior indicator is selected from a predetermined group of behaviors for each avatar based on the hand ranking. The social meter is dependent on the confidence and stress levels of a player. The confidence level of a player is influenced by the current card score (hand ranking). The stress level of a player is influenced by the longevity of the game and their confidence level. Therefore, in an embodiment, the stress level of each avatar increases at predetermined increments as a function of the longevity of the game. The resulting stress level will select a composure which produces a behavior indicator directly in the on-screen avatar. The players can bluff by choosing habits common to their character avatar which diminishes their stress level and results in a behavior indicator indicative of lower stress which is indicative of a better card score than their actual card score. Another way to bluff is to cause the avatar to repeat the same stress-relieving habits which make it seem that this computerized character is trying to calm themselves down even though their stress level is low, their confidence is high and their score is good; this makes an opponent think that ones card score is worse than it is. Players can therefore read or misread (when opponents are bluffing) the body language of other avatars in order to make game judgments thereon.

The handheld units comprise shields to guard the private screen of each player.

A variety of on-line gaming environments can be networked with players in close proximity in some environments and players in remote areas in other environments, with all these environments being networked within a single game or within a virtual tournament.

With reference to the appended drawings, non-restrictive illustrative embodiments of the present invention will be described herein so as to exemplify the invention and not limit the scope thereof.

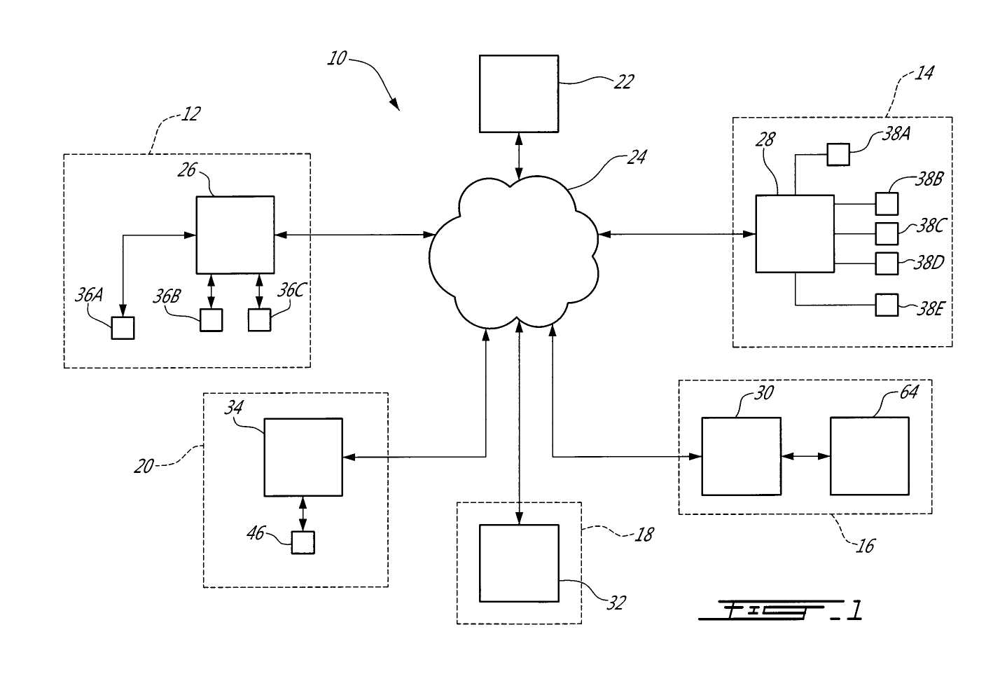

FIG. 1 shows a basic block diagram illustrating a gaming network 10 that includes, in this example, five remote gaming environments 12, 14, 16, 18 and 20. A host server 22 that hosts the video games of the present invention is connected, via the internet 24, to remote devices, 26, 28, 30, 32 and 34 in each remote gaming environment, 12, 14, 16, 18 and 20 respectively. The remote devices 26, 28, 30, 32 and 34 can be PC terminals with display screens to display the video games of the invention.

More particularly, gaming environment 12 includes a remote device 26 to be used by a variety of players, in this case three players; each player uses a controller such as handheld units 36A, 36B and 36C. Similarly, environment 14 includes a remote device 28 to be used by a variety of players, in this case five players; each player uses a controller such as handheld units 38A, 38B, 36C, 38D and 38E.

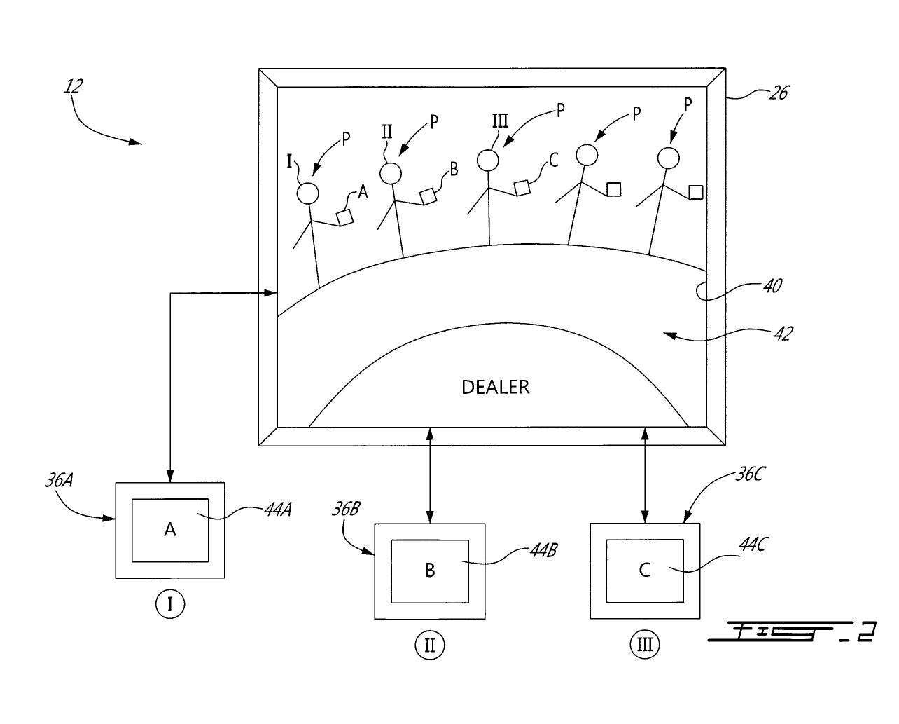

Turning to FIG. 2, an enlarged version of gaming environment 12 is shown. The remote device 26 is a PC terminal with a common interface in the form of a display screen 40 displaying an image or scene 42. Scene 42 shows a number of computer representations or avatars P for each player in a card game. The three players in the gaming environment 12 are facing the same common screen 40 and can see the same image or scene 42. Both the three players and their respective avatars P are denoted I, II and III. Each player avatar I, II and III has a hand of cards, namely A, B and C respectively. The respective hand A, B and C of each player I, II and III is not shown on the common image 42 but is only visible to each player via the private interface of their handheld unit 36A, 36B or 36C. In essence, these hands are Hole Cards (when the card game is Poker for example). More specifically, each handheld unit 36A, 36B and 36C includes a screen 44A, 44B, 44C displaying an image which is the Hole Card hand, A, B or C of each avatar I, II and III respectively. Therefore, only player I can see their hand A via screen 44A and so on. In this way, each player can evaluate their respective hand ranking.

Image 42 shows five players P, yet in the non-limiting example of the network 10 there are twelve possible players, as will be understood from the description below. Hence, in another non-illustrated embodiment of the present invention, image 42 would include all twelve player avatars interactively playing in network environment 10. Of course, it is also possible that the players in gaming environment 10 are divided into three groups (or “tables”) of four players and that the game consists of two rounds. In a first round, each group of four players will have access to a respective common image (i.e. there will be four common images) as well as their own private hand (which cannot be viewed by other players). Hence, there will be four common images, one for each group of players, each group of players will have four hands of cards, visible only to each respective player. In the second round, the top two players of each group moves to a second game made up now of six players. In this second round, there will be one common image and six different hands of cards (one per player). In still another embodiment, image 42 can be a close-up of five of the twelve players' avatars. Furthermore, a given player can play on multiple tables. Of course, the skilled artisan will easily appreciate that a plurality of group and scene permutations are possible with larger or smaller number of total players within the context of the present invention, and that the examples given herein serve only to exemplify certain possible game scenarios.

Referring again to FIG. 1, gaming environment 14 is similar to gaming environment 12 only that in the former case there are five players viewing the same common screen displayed by the remote device 28 with each player having a handheld unit, 38A, 38B, 36C, 38D and 38E; each unit displaying a respective private hand visible only to that given player.

Gaming environment 20, which is also similar to gaming environments 12 and 14, includes remote device 34 for displaying the common image as well as one handled unit 46 for its single player.

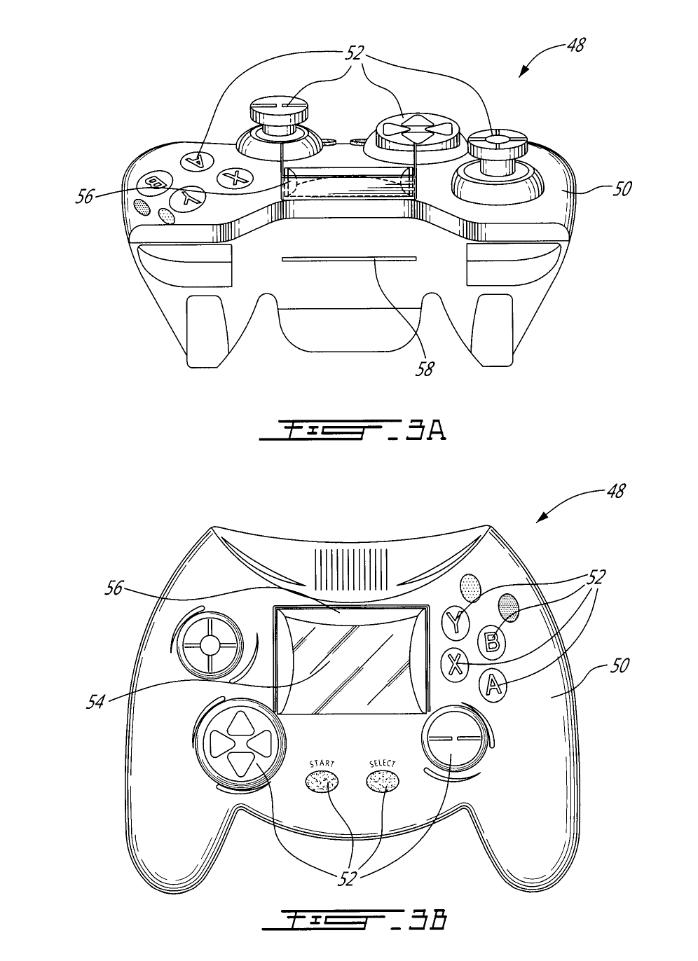

FIGS. 3A and 3B show an example of the controllers or handheld units described above and generally denoted here by reference numeral 48. A shown, the handheld unit 48 includes a main body 50 with control elements 52 as well as an integrated screen 54 for displaying a hand of cards. The screen 54 is bordered by a protective shield 56 which blocks other users in close proximity from seeing the hand of cards (image displayed on screen 54) of a given player. The shield 56 can be provided in a variety of configurations, for example it may be in the form of an ATM code panel shield or a pivotable door member that can be selectively raised to view one's hand. The unit 48 can be linked to the terminal having the common screen via a wire or via a wireless connection as is known in the art. The main body 50 also includes a slot 58 for receiving a credit card or the like. In this way, the player can pay on-line when playing the video games of the present invention; the credit card can also be used to place bets when the game includes wagers.

In another embodiment of the present invention, the screen 54 is a touch screen and the player can control its respective computer image avatar via this screen.

Returning to FIG. 1, the gaming environment 18 is shown to include one remote device 32 (such as a PC terminal, a video machine at an arcade, or other type devices known in the art). In gaming environment 18, there is no handheld unit similar to the one described above as such, the player's hand is shown on the same screen as the common image.

More specifically and with reference to FIG. 4, the remote device 32 is a PC terminal including a screen 60 for displaying the common image or scene 42. The player at terminal 32 controls its player avatar IV in the video game image 42 and holds a hand of cards D which is displayed within an auxiliary image box or icon 62 appearing within image 42 but being only displayed on screen 60, the common images 42 viewed by other players does not include the image box 62 with an image of hand D.

Gaming environment 16, shown in FIG. 1, is similar but differing only in the fact that it includes a first remote device 30 and a second remote device 64 that can be linked to the same CPU or that can be independent therefrom. In this case, the two remote devices 30 and 64 are used by different players and are in physical proximity to one another but so spaced or positioned that their respective screens are only visible to the players using that particular terminal 30 or 64.

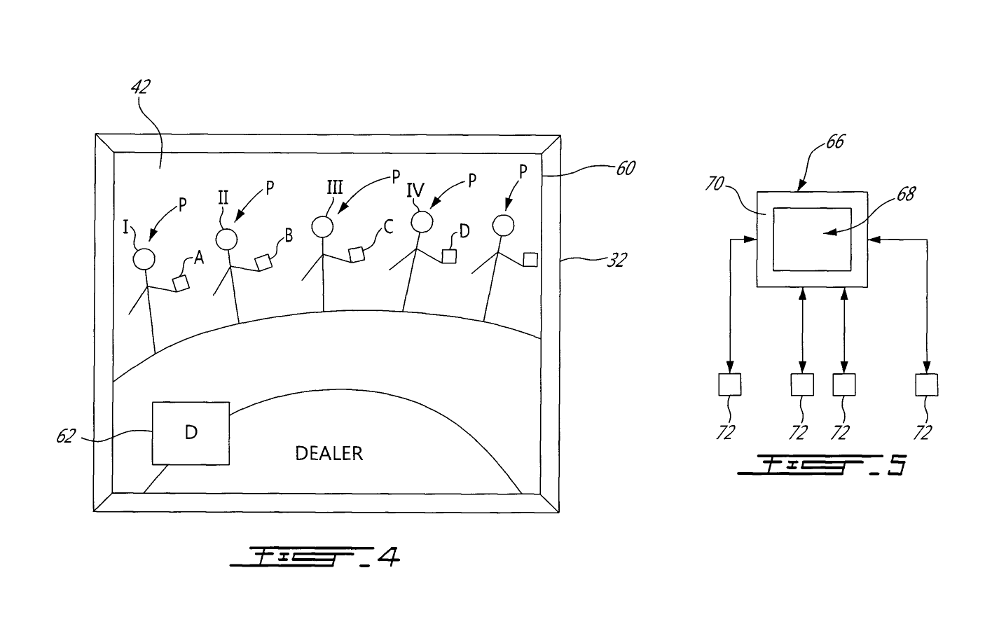

FIG. 5 shows another non-restrictive illustrative embodiment of the present invention. In this case, a processor 66 such as a computer runs the software for the present video game and displays a common image 68 within screen 70. The common image 68 is similar to image 42, showing personified computer images or avatars for each player holding a hand of cards. The hand of cards of each player is displayed on their respective handheld unit 72. Thus the present video game need not be played on-line but directly on a processor.

Turning now to FIG. 6, another non-restrictive illustrative embodiment of the present invention will now be described.

FIG. 6 shows a gaming environment 74 having a terminal 76 with a screen 78 showing a common image or scene 80 to four players, all of which are represented by their respective computer image avatars I′, II′, III′, and IV'. Each player's avatar I′, II′, III′, and IV′ is shown holding a hand of cards, namely hands A′, B′, C′ and D′, respectively. These hands of cards are only visible to each player via their handheld units 82A, 82B, 82C and 82C as previously explained above.

The active player, in this case player II′, is highlighted 84, when it is their turn to play. The present game provides for showing the social behavior or composure of the player avatar II′. In scene 80, the avatars are shown as stick figures, in these cases an auxiliary image box or icon 86 appears next to the active player. The image box 86 includes an image 88 of a behavior indicator. The behavior indicators are controlled by each player yet these indicators are based on how the game is proceeding for each of these players. The behavior indicator is therefore ultimately based on a player's score (hand ranking) during the card game and can be adjusted by stress relief controls accordingly by each player during the game. The behavior indicators that can appear next to each image include: Over-confident, Happy, Nervous, Calm, Irritated, Discouraged etc. to give but a few examples. As such the behavior indicator is a term associated with each avatar.

In another non-illustrated embodiment that can easily be contemplated by the skilled artisan within the context of the present invention, the avatars are three-dimensional cartoon images which act out their behavior indicators. Hence, there is no image box or icon appearing next to the avatar but this character will act in certain ways to emulate a real life game scenario. In essence, the avatars act in certain ways (over-confident, happy, nervous, calm, irritated, discouraged etc.); the other players will make judgments based on this behavior. Therefore the behavior indicator is a behavior action performed by the avatar. The action is selected from a group of predetermined acts performed by the avatar.

The three-dimensional avatars are responsive to social meters.

There are three controlling factors that affect the behavior of an avatar: (1) stress (2) confidence, and (3) composure.

(1) Stress: Card games are a stressful experience. Each avatar have a habit they perform (drink, play with their chips, fidget, etc.) to reduce their stress level. During a game the stress level rises in a constant manner, performing these habits helps keep it in check.

(2) Confidence: Each character or avatar has a base Confidence Level. As more hands are won or lost, the level of confidence will shift depending on the players score. The Confidence Level affects the speed at which the Stress Meter rises. High Confidence slows down the Stress Meter, while Low Confidence causes the Stress Meter to rise quickly and eventually affects the avatar's Composure. Confidence changes at the end of each hand (or play).

(3) Composure: Composure is set (by the player) right before every playing round (betting cycle). A selected composure dictates the on-screen appearance and demeanor of a player's avatar (looking happy, calm, angry, nervous or irritated). When new cards are received, a Composure Meter is adjusted based on a pre-selected score such as card quality (Excellent, Good, Average, Mediocre, Bad) and stress (the higher the stress level, the greater the impact on Composure.) In an embodiment, there is also provided a composure modulator for modulating the Composure Meter. In one embodiment, this composure modulator is in the form of a habit controller discussed below.

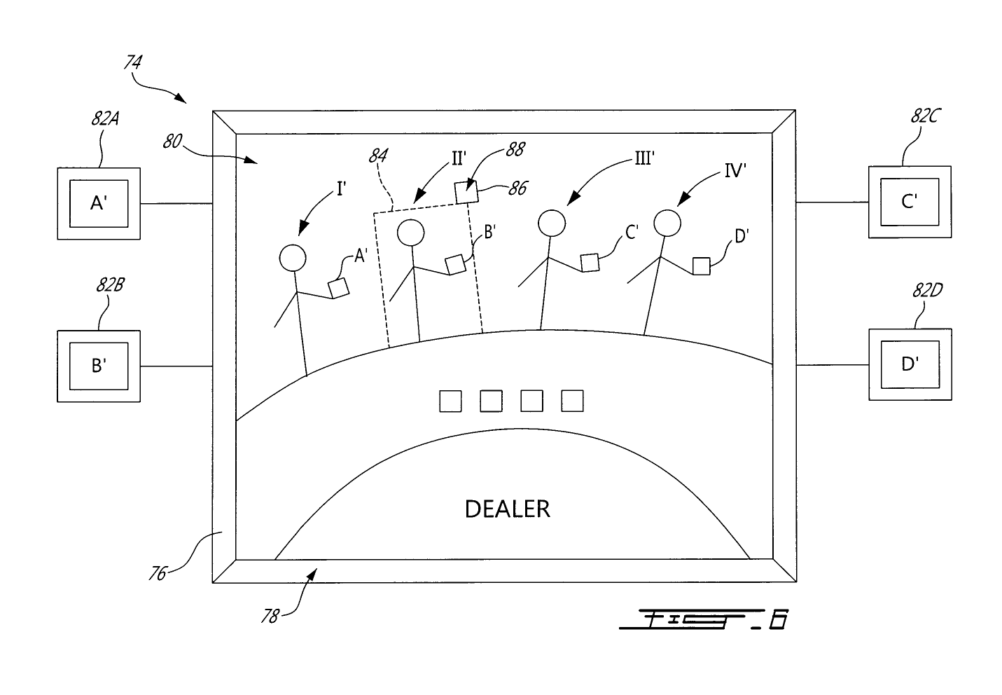

Turning now to FIG. 7, a block diagram represents a non-restrictive illustrative embodiment of the present method 90 of the video card games. The block diagram 90 shows the Social Meter 92 its influence on the behavior indicator 94 of a player's avatar. The Social Meter includes a Score Meter 96, a Confidence Meter 98, a Stress Meter 100, a Composure Meter 102, and a Habit Controller 104.

FIG. 8 is an enlarged view of the Confidence Meter 98 which shows several predetermined Confidence Levels (Low, Medium, High). The initial Confidence Level of a player is pre-set, this initial Confidence Level can be randomly attributed or can be based the avatar character selected by the player. Certain characters may have more initial confidence than others who are naturally more insecure. The game may also have a memory to adjust the general Confidence Level of a given character avatar depending on their playing history.

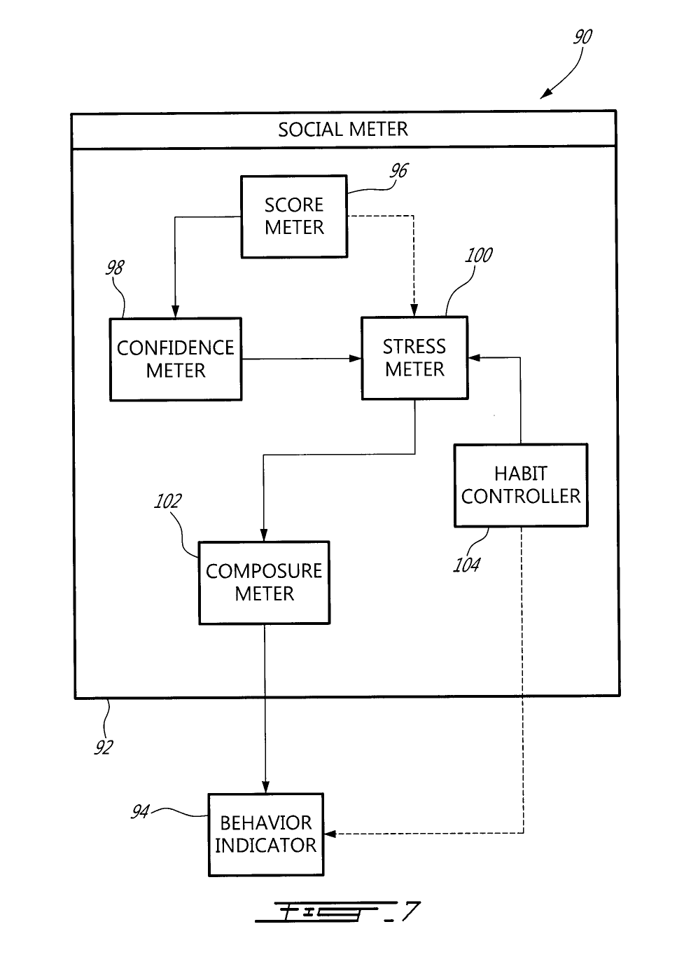

FIG. 9 is an enlarged view of the Stress Meter, which shows several predetermined Stress Levels (Low, Medium, High). The Stress Meter naturally rises as the game progresses and the Confidence Meter affects the speed at which the Stress Levels rise.

FIG. 10 is an enlarged view of the Composure Meter showing different Composure Levels: Ecstatic, Happy, Calm, Mildly Nervous, Very Nervous, Discouraged, and Irritated. These Composure Levels are selected based on the Stress Level. The various Composure Levels dictate a behavior indicator that is acted out by the character avatar. For example, the Very Nervous Composure Level produces a behavior indicator in a character avatar showing the avatar sweating heavily and looking at his opponents and at his hand constantly. The Calm Composure Level produces a behavior indicator that causes the character avatar to look cool and collected. The Happy Composure Level produces a behavior indicator that shows the character avatar smiling and looking excited about the game. Of course, the skilled artisan will easily understand that a variety of emotional and behavioral actions can be selected in order to indicate a given Composure Level.

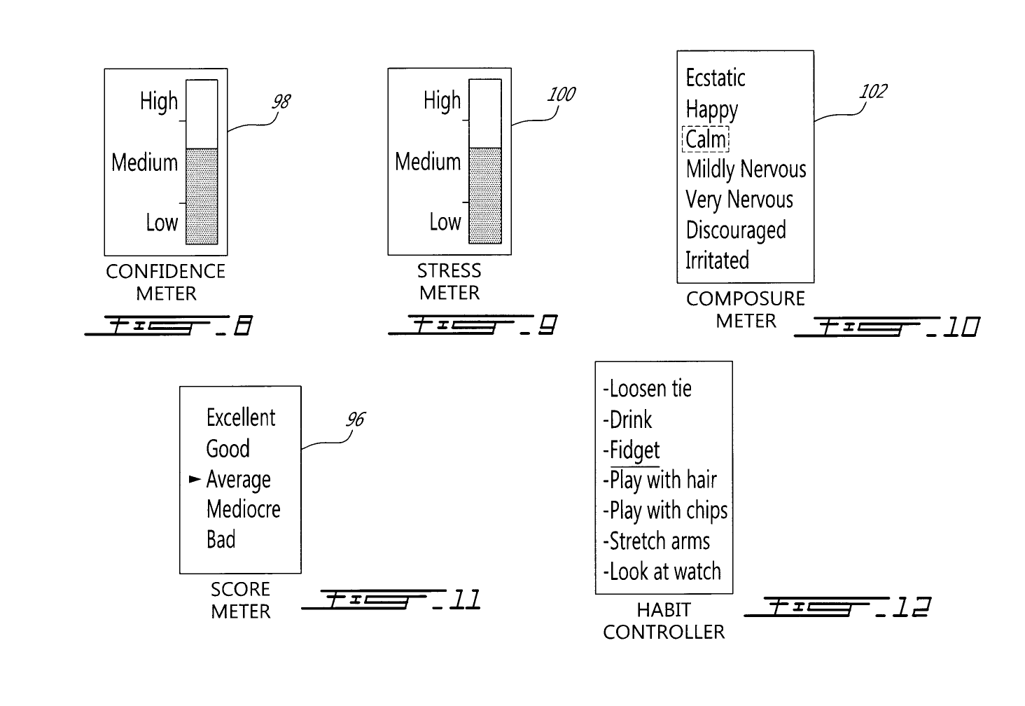

FIG. 11 shows an enlarged view of the Score Meter 96. A given dealt hand of cards has a given hand ranking or Score Level (Excellent, Good, Average, Mediocre, Bad) depending on the game. A high Score Level produces a High Confidence Level which slows down the Stress Level as it rises during the game. The player can thus keep a Calm Composure Level for example. A low Score Level produces a Low Confidence Level which speeds up the rise in Stress Level causing a Calm Composure Level to drop to a Mildly Nervous Composure Level. The foregoing Composure Level produces a behavior indicator in the player's on-screen avatar which can consist of showing the computer character sweating mildly.

A player does not want to reveal their true Composure Level which is indicative of their Stress Level to the other players. As such, the Habit Controller 106 (an enlarged view being shown in FIG. 12) provides for selecting certain actions (Loosen Tie, Drink, Fidget, Play With Hair, Play With Chips, Stretch Arms, Look at Watch, Wipe Sweat) that when repeated or combined bring down the Stress Level or slow down its rise no matter what the Confidence Level is and thus modify the Composure Level which of course produces another Behavior indicator. In an embodiment, the Habit Controller 106 can reduce the Stress Level within a predetermined range. In one embodiment, this range is provided by the current hand ranking.

Of course, other players may see these Habits as being indicative of a higher Stress Level, which of course indicates a low quality hand of cards (or low hand ranking). The player may also repeat and combine some of these Habits when their Confidence Level is high (i.e. when the have a relatively good to excellent hand) in order to make this player's opponents believe that he or she is more nervous than their on-screen character avatar appears to be. As such, the present invention provides for a wide degree of bluffing.

Returning now to FIG. 6, it has been explained that each player has a handheld unit 82A, 82B, 82C and 82D; the screen of these handheld units not only displays the private card hand of each player, but also images related to their Score Meter 96, Confidence Meter 98, Stress Meter 100, Composure Meter 102, and Habit Controller 104. The Habit Controller 104 may also be controlled via control elements (such as 52 mentioned above for FIGS. 3A and 3B). The players of course use their handheld units to place their bets, call and raise, as well as monitor their behavior indicators via the displayed social meter 96.

In one non-restrictive embodiment, the video card game of the present invention is Poker. Below is a non-limiting example of the various phases of such a game in accordance with a non-restrictive embodiment of the present invention,

Phases of Play

Phase 1: New Hand.
Players select initial composure
Cards are dealt
Betting 1: Players ante up.

Phase 2—The Deal
Cards are dealt face down to each player.
(Composure Level is adjusted + or −).
Betting 2: During each player's turn to bet, players bet on their two cards. They can adjust their composure to prepare for a betting round.

Phase 3—The Flop
Cards are dealt by the dealer face up on the table, these are community cards. (Composure Level is adjusted + or −).
Betting 3: Players bet on their cards and can adjust their composure.

Phase 4—The Turn
One card is dealt face up to each player. (Composure Level is adjusted + or −).
Betting 4: Players bet on their cards and can adjust their composure.

Phase 5—The River
The final card is dealt face up. (Composure Level is adjusted + or −).
Betting 5: Players bet on their cards and can adjust their composure.

Phase 6—The Showdown
The Hands are revealed. Player with the highest hand wins. (Confidence Level is adjusted)

It should be noted that the various components and features described above can be combined in a variety of ways so as to provide other non-illustrated embodiments within the scope of the invention.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention.

1. A video card game for a plurality of players comprising:
a common interface viewable by all the players and displaying a plurality of computer avatars, each said avatar corresponding to one given player and holding a respective hand of cards corresponding to a hand ranking that is selectively not displayed by said common interface; and
a plurality of private interfaces, each private interface displaying one given said hand of cards of one given said avatar, said one given hand of cards being selectively viewable only by the player that said one given avatar corresponds to; and
a social meter for each said avatar, said social meter modulating a behavior indicator for each said avatar,
wherein the players selectively replace one card or more of their respective said hand of cards for modifying their respective said hand ranking, wherein a given said hand of cards is selectively displayed on said common interface thereby allowing all the players to assess said hand ranking thereof.

2.-7. (canceled)

8. A video card game according to claim 1, wherein said common interface is provided by a terminal display screen.

9. A video card game according to claim 1, wherein said private interfaces are respectively provided by handheld consoles having integrated screens.

10. A video card game according to claim 1, wherein each player selectively controls their corresponding said avatar via a controller.

11. A video card game according to claim 10, wherein said controller comprises a handheld console.

12. A video card game according to claim 1, wherein each said avatar is provided with a turn to play comprising a play activity.

13.-14. (canceled)

15. A video card game according to claim 1, wherein said behavior indicator is selected from a group of predetermined behaviors.

16.-20. (canceled)

21. A video card game according to claim 1, wherein said social meter comprises a confidence meter.

22. A video card game according to claim 21, wherein said confidence meter comprises a plurality of predetermined confidence levels, wherein the lower of two given said confidence levels is indicative of a relatively lower confidence and the higher of two given said confidence levels is indicative of a relatively higher confidence.

23.-26. (canceled)

27. A video card game according to claim 21, wherein said social meter further comprises a stress meter.

28. A video card game according to claim 27, wherein said stress meter comprises a plurality of predetermined stress levels, wherein the lower of two given said stress levels is indicative of relatively lower stress and the higher of two given said stress levels is indicative of a relatively higher stress.

29. A video card game according to claim 28, wherein said stress level of each said avatar increases at predetermined increments as function of the longevity of the game.

30. A video card game according to claim 28, wherein said confidence level affects the speed at which said stress level increases, wherein a given said higher confidence level causes said stress level to increase at a faster speed than a given said lower confidence level.

31. (canceled)

32. A video card game according to claim 27, wherein said social meter further comprises a composure meter for directly producing said behavior indicator.

33. A video card game according to claim 32, wherein said composure meter comprises a plurality of composure levels, said stress meter producing a given said composure level.

34. (canceled)

35. A video card game according to claim 33, wherein a given composure level produces a given behavior indicator indicative of said given stress level.

36. A video card game according to claim 32, wherein said social meter further comprises a composure modulator of modulating said composure meter, said composure meter being controllable by each player so as to modify said composure meter of their said avatar.

37. (canceled)

38. A video card game according to claim 36, wherein said composure modulator comprises a habit controller for producing a said behavioral indicator selected from a plurality of predetermined indicators associated to said avatar, said behavioral indicator resulting in reducing said stress level of said avatar.

39.-41. (canceled)

42. A video card game according to claim 21, wherein said social meter further comprises a score meter.

43. A video card game according claim 42, wherein said score meter is indicative of said hand ranking appearing in said private interface.

44. A video card game according to claim 42, wherein said score meter comprises score levels, a given higher said score level producing a higher said confidence level than a given lower said score level.

45. A video card game for a plurality of players comprising:
a common interface viewable by all the players and displaying a plurality of computer avatars, each said avatar corresponding to one given player and holding a respective hand of cards corresponding to a hand ranking;
a controller for each player for selectively controlling their respective said avatar for replacing one card or more of their respective said hand of cards thereby modifying their respective said hand ranking; and
a social meter for modulating a behavior indicator selected from a group of predetermined behaviors for each said avatar based on said hand ranking,
wherein said behavior indicator for each said avatar is displayed by said common interface so as to be viewable by all the players.

46.-80. (canceled)
